(19) United States
(12) Patent Application Publication
(10) Pub. No.: US 2007/0172618 A1
(43) Pub. Date: Jul. 26, 2007

(54) Adhesive tape article for masking door hinges

(75) Inventor: Russel J. Schivley, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/340,382

(22) Filed: Jan. 26, 2006

(51) Int. Cl. B32B 33/00; B32B 23/02

(52) U.S. Cl. 428/40.1; 428/194

(57) ABSTRACT

An adhesive article for masking a door hinge includes a flexible backing layer having opposed first and second major surfaces with the backing layer first major surface being free of adhesive and the backing layer second major surface including an adhesive region and a non-adhesive region. A pad of such tape masking articles and a method of masking a door hinge using the tape masking articles are also described.

### BACKGROUND

The present invention relates generally to paint masking and, more particularly, to a disposable sheet-like tape article for masking door hinges.

When applying a coating, such as paint or stain, to a door or door jamb, care must be taken so that paint does not get on the door hinge. This can be accomplished by carefully painting around the door hinges, removing the door and the hinges from the door and door jamb, painting the door and door jamb, and then and re-hanging the door, or by carefully taping the door hinges and cutting the tape so that it covers only the door hinge. These approaches, however, are tedious, time-consuming, and/or difficult.

Paint masking articles for masking door hinges are known in the prior art. U.S. Pat. No. 5,056,191 (Love), for example, discloses a paint mask for a butt hinge and a masking method for protecting the hinge against paint spray or the like. U.S. Pat. No. 5,722,120 (Bindschatel et al.) discloses a pre-stamped half hinge adherent cover designed to protect the exposed surfaces of a half-hinge attached within the hinge recess of a door or jamb during the operation of coating.

There is still a need, however, for an inexpensive hinge masking article that is easy to make and easy to use.

### SUMMARY

The present invention provides an adhesive tape article for masking door hinges that is inexpensive, easy to make and easy to use. The tape article is meant to be a single use item that is generally not reusable. The tape article is generally designed to mask one-half of a door hinge, whereby two of the tape articles can be used to mask the entire door hinge.

In one embodiment, the present invention provides an adhesive article comprising a flexible backing layer having opposed first and second major surfaces, opposed first and second side edges and opposed first and second end edges. The backing layer first major surface is free of adhesive and the backing layer second major surface includes an adhesive region and a non-adhesive region.

In one aspect, the non-adhesive region may extend along the perimeter of the adhesive article adjacent at least a portion of one of the side and end edges. In another aspect, the non-adhesive region may be arranged adjacent the first side edge. In a more specific aspect, the non-adhesive region may extend from the first end edge to the second end edge of the backing layer. In an even more specific aspect, the non-adhesive region may extend from about 2 mm to about 10 mm from the first side edge in the direction of the second side edge.

In one embodiment, the first side edge and the second side edge may be generally linear and generally parallel. The first end edge and the second end edge may include symmetric arcuate portions in the region proximate the second side edge.

In various aspects, the backing layer is formed of a sheet-like material such as paper or film. The adhesive region typically includes a pressure-sensitive adhesive.

In a specific embodiment, the non-adhesive region is formed by a layer of non-adhesive material arranged over the adhesive region. In a more specific embodiment, the first and second side edges of the backing layer are asymmetric, and the first and second end edges of the backing layer are symmetric. Or, stated another way, the tape article is longitudinally asymmetric and transversely symmetric.

In another embodiment, the present invention provides a pad of adhesive articles for masking a door hinge wherein the pad comprises a plurality of flexible sheets disposed one on top of another, thereby to form a stack of sheets. Each sheet comprises a flexible backing layer having opposed first and second major surfaces, opposed first and second side edges and opposed first and second end edges. The backing layer first major surface is free of adhesive and the backing layer second major surface includes an adhesive region and a non-adhesive region. Each sheet in the pad may further include any of the various other features described herein. The pad may also further comprise a liner arranged on the bottom of the pad.

The present invention also provides a method of masking a door hinge having a pair of leafs rotatably connected by a hinge mechanism. The method comprises the steps of (a) providing a pair of matching tape masking articles, each tape masking article comprising a flexible backing layer having opposed first and second major surfaces, opposed first and second side edges and opposed first and second end edges, the backing layer first major surface being free of adhesive and the backing layer second major surface including an adhesive region and a non-adhesive; (b) arranging a first one of the tape masking articles over a first one of the hinge leafs with the non-adhesive region arranged in overlapping relation with the hinge mechanism; and (c) arranging the second one of the tape masking articles over the second one of the hinge leafs with the non-adhesive region arranged in overlapping relation with the hinge mechanism, and typically in overlapping relation with the non-adhesive region of the first tape masking article

Advantages of certain embodiments of the invention include that the masking article has a non-adhesive region arranged to allow a user to readily grasp the tape article and remove it from a pad of such tape articles. In addition, the non-adhesive region prevents the tape masking article from interfering with the operation of the door hinge. The non-adhesive region also minimizes the extent to which a user must touch the adhesive region of the tape article during handling and during the application of the article to the door hinge.

In addition, the present invention provides a pad of hinge masking articles that is lightweight and compact. The pad of hinge masking articles is preferably thin enough so it may be placed between the fingers of a user during the application of the masking articles to a hinge, thereby producing additional time savings.

### BRIEF DESCRIPTION OF THE DRAWINGS

The present invention will be further described with reference to the accompanying drawings, in which:

FIG. 1a is a top plan view of an adhesive tape masking article for masking door hinges according to the invention;

FIG. 1b is a bottom plan view of the tape masking article of FIG. 1a;

FIG. 2 is a cross-sectional view taken along line 2-2 of FIG. 1a;

FIG. 3 is a perspective view showing the tape masking article being applied to a door hinge;

FIG. 4 is a perspective view of a pad of adhesive tape masking articles; and

FIG. 5 is a cross-sectional view taken along line 5-5 of FIG. 4.

### DETAILED DESCRIPTION

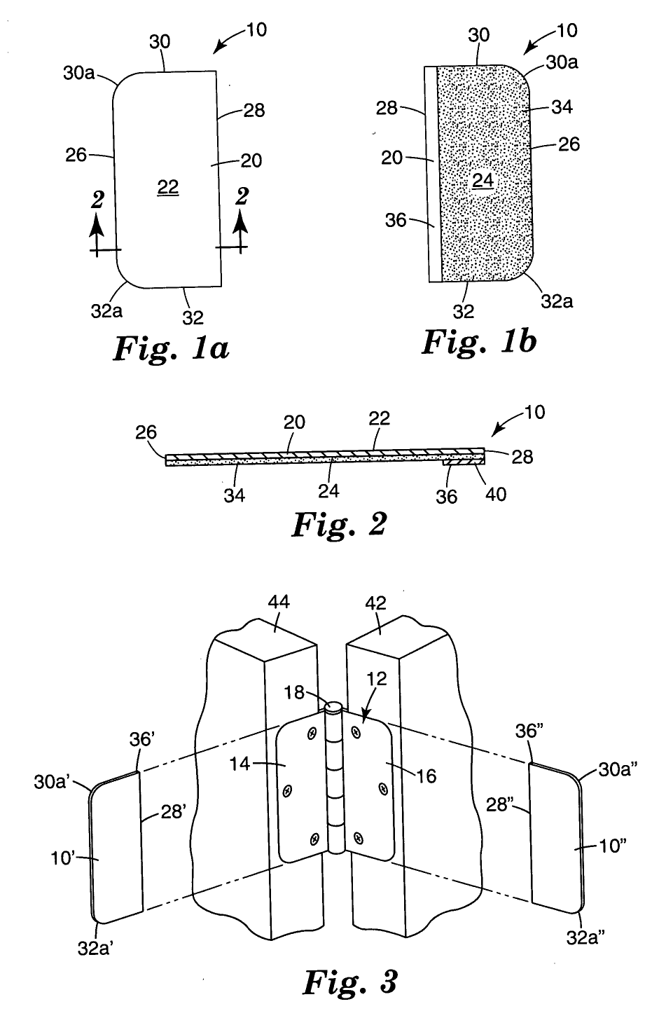

Referring now to the drawings, wherein like reference numerals refer to like or corresponding parts throughout the several views, and functionally similar features are referred to with like reference numerals incremented by 100, FIGS. 1-2, show an adhesive tape masking article 10 designed to mask conventional door hinges. As shown in FIG. 3, such door hinges 12 generally include a pair of leafs 14, 16 that are pivotally connected by a hinge mechanism 18.

The tape masking article 10 comprises a relatively thin flexible sheet-like material that defines a backing layer 20 having opposed first 22 and second 24 major surfaces, opposed first 26 and second 28 side edges, and opposed first 30 and second 32 end edges. The backing layer 20 first major surface 22, which may be thought of as the top surface of the article 10, is free of adhesive. The backing layer 20 second major surface 24, which may be thought of as the bottom surface of the article, includes an adhesive region 34 and a non-adhesive region 36. In the illustrated embodiment, the non-adhesive region 36 is provided along an edge of the tape masking article 10.

The backing layer 20 may be formed of any suitable flexible sheet material that is sufficiently durable to withstand the requirements of masking, can be coated with an adhesive, and is otherwise suitable as a masking tape backing. Suitable materials include, for example, paper, such as the paper used for conventional masking tapes. Such paper may be creped, and may be provided in various grades, thickness, and/or weights. Other papers, such as bond paper, for example, may also be used. In addition, the backing layer 20 may be formed of polymeric films or other flexible sheet-like materials.

The adhesive region 34 may cover the interior region of the second major surface 24 as shown in FIG. 1b, or it may cover only the perimeter of the second major surface 24 adjacent at least one of the first and second edges 30, 32, and the first side edge 26, whereby the central region (i.e. the interior region) of the second major surface 24 is non-adhesive. Other patterns for the adhesive 34 and non-adhesive 36 regions are also contemplated. The adhesive region 34 typically includes a pressure sensitive adhesive (PSA), such as those typically used for masking tapes. Suitable PSA's include, for example, repositionable PSA's, natural or synthetic tackified rubber PSA's, or acrylic PSA's.

In the illustrated embodiment, the non-adhesive region 36 extends from the first end edge 30 to second end edge 32 of the backing layer 20 adjacent the second side edge 28. Arranged in this manner, the non-adhesive region 36 provides a non-adhesive tab that allows a user to readily grasp the article 10 and easily remove it from a pad (or stack) of tape masking articles. In addition, the non-adhesive region 36 minimizes the extent to which the user must touch the adhesive during the application of the masking article 10 to the door hinge during the masking process. And, as explained more fully below, when the article is applied to the door hinge, the article 10 is configured so the non-adhesive region 36 overlays the hinge mechanism 18. In this manner, the door hinge mechanism 18 may rotate freely after the masking article 10 has been applied to the door hinge 12. That is, the non-adhesive region 36 allows the masking article 10 to be used to mask the door hinge 12 without interfering with the door hinge's 12 ability to rotate.

In the illustrated embodiment, the non-adhesive region 36 typically extends from about 2 millimeters (mm) to about 10 mm from the second side edge 28 toward the first side edge 26. That is, the non-adhesive region 36 is approximately 2 to 10 mm wide. More typically, the non-adhesive region 36 is about 4 mm to about 8 mm wide. In one aspect of the invention, the non-adhesive region 36 has a width that is equal to or greater than the radius of the hinge mechanism 18, whereby when the masking article 10 is applied to a leaf of a door hinge, the non-adhesive region 36 will cover at least half of the hinge mechanism.

In the illustrated embodiment, the non-adhesive region 36 is created by applying a layer of material 40 over the adhesive region 34. The material 40 may be the same as the material used for the backing layer 20 such as, for example, paper or polymeric sheet-like materials, which may or may not include adhesive. For example, the material 40 may comprise a strip of masking tape or a plain paper. More generally, the non-adhesive region 36 may be formed by any known method of producing a nonadhesive region, such as by applying a non-adhesive material onto the adhesive to render it non-tacky, or by otherwise treating or detackifying the adhesive so it is rendered non-tacky. Alternatively, the non-adhesive region 36 may be formed by not coating the nonadhesive region 36 with adhesive. Such an embodiment is illustrated in the embodiment shown in FIG. 5, described below.

In the illustrated embodiment, the first side edge 26 and the second side edge 28 of the backing layer 20 are generally linear and generally parallel. In addition, the first end edge 30 and the second end edge 32 include symmetric arcuate portions 30a, 32a in the region proximate the first side edge 26. The illustrated shape is intended to closely match the shape of many commercially available door hinges. Furthermore, the first 26 and second 28 side edges of the backing layer 20 are asymmetric while the first 30 and second 32 end edges of the backing layer 20 are symmetric. That is, if the masking article 10 is folded longitudinally such that the first and second side edges 26, 28 are brought together, the perimeter of the article will not be aligned. Rather, the corner of the second side edge 28 will extend outwardly beyond the corresponding arcuate portions 30a, 32a. If the masking article is folded transversely such that the first and second end edges 30, 32 are brought together, the perimeter of the article will be aligned. The size and shape of the article 10 as illustrated generally corresponds to the size and shape of a widely commercially available door hinge. The size and shape of the article, however, can vary depending on the size and shape of the door hinge being masked.

FIG. 3 illustrates a conventional door hinge 12, which includes a pair of leafs 14, 16 pivotally connected by a hinge mechanism 18, being masked using a pair of the tape masking article 10 shown in FIG. 1. The door hinge 12 is arranged between a doorjamb 42 and a door 44. The hinge 12 is masked by first aligning a first tape masking article 10′ so the profile of the masking article 10′ matches the profile of a first one of the hinge leafs 14. That is, the masking article 10′ is arranged so the curved portions 30a′, 32a′ of the article 10′ are aligned with the corresponding curved portions of the hinge leaf 14, and the second side edge 28′ is aligned with the hinge mechanism 18. The masking article 10′ is then adhered to the hinge leaf 14 such that non-adhesive region 36′ is arranged in overlapping relation with the hinge mechanism 18. In this manner, each masking article 10′ covers one leaf and, preferably, at least half of the hinge mechanism 18.

Then, a second tape masking article 10″ is similarly placed over the second hinge leaf 16. That is, the second tape masking article 10″ is aligned with the second hinge leaf 16 so the profile of the masking article 10″ matches the profile of a second hinge leaf 16. Thus, the masking article 10″ is arranged so the curved portions 30a″, 32a″ of the article 10″ are aligned with the corresponding curved portions of the second hinge leaf 16, and the second side edge 28″ is aligned with the hinge mechanism 18. The masking article 10′ is then adhered to the hinge leaf 16 such that the non-adhesive region 36″ is arranged in overlapping relation with the hinge mechanism 18. In addition, to provide full coverage of the hinge mechanism 18, the non-adhesive region 36″ of the second masking article 10″ is typically arranged in overlapping relation with the non-adhesive region 36′ of the first tape masking article 10′.

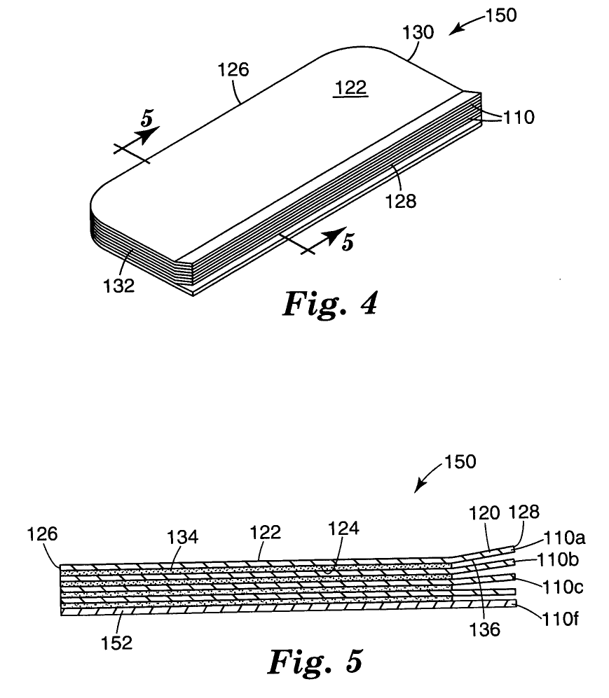

Referring now to FIGS. 4 and 5, in which features similar to those shown in FIGS. 1-3 are referred to with like reference numerals incremented by 100, there is shown pad 150 of adhesive articles 110 for masking a door hinge. The pad 150 comprises a plurality of flexible sheets 110a, 110b, 110c disposed one on top of another. In the illustrated embodiment, each sheet 110 directly contacts the adjacent sheet(s). That is, the sheets 110 are not separated by release liners. When the sheets are arranged in this directly contacting configuration, the first major surface 122 of each sheet 110 is typically provided with a low adhesion backsize (LAB—not shown) so the upper most sheet can be easily separated from the pad 150. That is, the LAB facilitates the removal of each sheet from the stack of sheets, which may not otherwise be possible depending on the type of adhesive and type backing used in the construction of the sheets 110. The particular LAB selected will depend on the particular adhesive used, but the two are matched so each sheet 110 can be removed from the pad without tearing or damaging the sheet being removed or the underlying sheet. Alternatively, each sheet may be separated by a release liner (not shown), but such release liners add to the overall cost of the pad 150 and produce unwanted waste material that must be disposed of.

The number of sheets 110 in the stack 150 is not significant to the invention and may vary depending on the requirements of the end user. In one aspect of the invention, the number of sheets in the pad is sufficiently small (e.g. less than 25 sheets) that the overall thickness of the pad 150 allows a user to place the pad between his or her fingers during the application of the article 110 to the door hinge. That is, the pad 150 is preferably small and lightweight enough so that, even if the user holds the pad throughout the application of the article to the hinge, the pad 150 will not significantly interfere with the user's ability to apply the article 110. In a preferred aspect, the overall thickness of the pad is typically less than about 15 mm, more typically less than about 10, and even more typically, less than about 8 mm. By providing a pad that is sufficiently thin, the need to put the pad down and retrieve it each time an article is applied to a hinge is eliminated. This can produce considerable time savings when masking a large number of door hinges.

The construction of each sheet 110a, 110b, 11c is similar to the construction of the tape masking article 10 shown and described in reference to FIGS. 1 and 2 except the non-adhesive region 136 of the sheets 110 is formed by not coating the non-adhesive region 136 with adhesive rather than by applying a non-adhesive layer, such as material 40 in FIG. 2, over the adhesive.

Each tape masking sheet 110 comprises a flexible backing layer 120 having opposed first 122 and second 124 major surfaces, opposed first 126 and second 128 side edges, and opposed first 130 and second 132 end edges. The backing layer 120 first major surface 122 is free of adhesive, and the backing layer 120 second major surface 124 is provided with an adhesive that defines an adhesive region 134 that extends from the first side edge 126 in the direction of the second side edge 128, and a non-adhesive region 136 that extends from the adhesive region 134 to the second side edge 128.

An optional release liner 152 is provided on the bottom of the stack of sheets 150 to protect the adhesive surface of the bottom most tape masking sheet 110f Of and to serve as a base for the pad 150.

Persons of ordinary skill in the art may appreciate that various changes and modifications may be made to the invention described above without deviating from the inventive concept. For example, the masking article 10 may be provided with flaps or wings that can be folded over to mask the top and bottom of the hinge mechanism. Thus, the scope of the present invention should not be limited to the structures described in this application, but only by the structures described by the language of the claims and the equivalents of those structures.

What is claimed is:

1. An adhesive article designed to mask one-half of a door hinge, the article comprising a flexible backing layer having opposed first and second major surfaces, opposed first and second side edges and opposed first and second end edges, the backing layer first major surface being free of adhesive and the backing layer second major surface including an adhesive region and a non-adhesive region.

2. An adhesive article as defined in claim 1, wherein the non-adhesive region extends along the perimeter of the adhesive article adjacent at least a portion of one of the side and end edges.

3. An adhesive article as defined in claim 2, wherein the non-adhesive region is arranged adjacent the first side edge.

4. An adhesive article as defined in claim 3, wherein the non-adhesive region extends from the first end edge to the second end edge of the backing layer.

5. An adhesive article as defined in claim 4, wherein the non-adhesive region extends from about 2 mm to about 10 mm from the first side edge in the direction of the second side edge.

6. An adhesive article as defined in claim 1, wherein the first side edge and the second side edge are generally linear and generally parallel.

7. An adhesive article as defined in claim 6, wherein the first end edge and the second end edge include symmetric arcuate portions in the region proximate the second side edge.

8. An adhesive article as defined in claim 1, wherein the backing layer is formed of a material selected from the group consisting of paper and film.

9. An adhesive article as defined in claim 1, wherein the adhesive region includes pressure sensitive adhesive.

10. An adhesive article as defined in claim 1, wherein the non-adhesive region is formed by a layer of non-adhesive material arranged over the adhesive region.

11. An adhesive article as defined in claim 1, wherein the first and second side edges of the backing layer are asymmetric and the first and second end edges of the backing layer are symmetric.

12. A pad of adhesive articles for masking a door hinge comprising a plurality of flexible sheets disposed one on top of another, each sheet comprising a flexible backing layer having opposed first and second major surfaces, opposed first and second side edges and opposed first and second end edges, the backing layer first major surface being free of adhesive and the backing layer second major surface including an adhesive region and a non-adhesive region.

13. A pad of door hinge tape masking articles as defined in claim 12, further comprising a liner arranged on the bottom of the pad.

14. A method of masking a door hinge having a pair of leafs rotatably connected by a hinge mechanism, comprising the steps of:
(a) providing a pair of matching tape masking articles, each tape masking article comprising a flexible backing layer having opposed first and second major surfaces, opposed first and second side edges and opposed first and second end edges, the backing layer first major surface being free of adhesive and the backing layer second major surface including an adhesive region and a non-adhesive;
(b) arranging a first one of the tape masking articles over a first one of the hinge leafs with the non-adhesive region arranged in overlapping relation with the hinge mechanism; and
(c) arranging the second one of the tape masking articles over the second one of the hinge leafs with the non-adhesive region arranged in overlapping relation with the hinge mechanism and in overlapping relation with the non-adhesive region of the first tape masking article.
